(19) United States
(12) Patent Application Publication
(10) Pub. No.: US 2003/0110052 A1
(43) Pub. Date: Jun. 12, 2003

(54) Ribbon method for displaying milk and other products

(75) Inventors: Mario Capazario, Geneva (CH); Jeffrey Rubin, Richmond (AU)

Correspondence Address: DARBY & DARBY P.C., 805 Third Avenue, New York, NY, 10022, US

(73) Assignees: ProCorp USA Inc.; Pro Corp Holdings International Ltd.

(21) Appl. No.: 10/024,662

(22) Filed: Oct. 30, 2001

(51) Int. Cl. G06F 17/60

(52) U.S. Cl. 705/1

(57) ABSTRACT

A method of shelving items, especially milk, in a ribbon or vertical fashion. This method includes dividing up a product category into sections, and dividing those sections by size. This method also includes shelving each size vertically, the same size product on every shelf, from top to bottom, in a column. These columns are then arranged from left to right, with the smallest product column to the left and the largest product column to the right.

### BACKGROUND OF THE INVENTION

1. Field of the Invention

This invention relates to the field of inventory shelving and marketing. The method achieves greater sales by maximizing the range of products to be displayed at every shelf level and thus at eye level for every person regardless of height, and thus allows consumers to see and access every size product of a particular item or brand.

2. Discussion of the Related Art

Traditionally, most products displayed in a supermarket or any retail location that sells foods or beverages are in a horizontal arrangement. A horizontal layout of products groups like sizes of the same product together on one shelf and then different sizes of the same brand on the shelves above and below. For example, milk, traditionally, is sold where the largest (one gallon) containers are on the bottom shelf and the smallest containers (½ pint) on the very top shelf. This was traditionally done to maximize shelf spacing. Placing like size items on the same shelf allowed that shelf to be set at one height and the products had very little gap between shelves to maximize the use of shelf space.

However, this method of stocking, while maximizing shelf placement, makes size selection by the consumer more difficult. The ‘horizontal’ method places only one size out of many at any one eye level. In addition, the largest size item is typically placed on the lowest shelves, which is not at eye level for a majority of consumers. Yet the largest size item is typically the product that produces the most profit for the retailer and the wholesaler and the best value for the consumer. For example, milk alone comes in at least five (5) different sizes inside the United States (½ pint, pint, quart, ½ gallon and gallon) for each type (whole, skim, etc.) of milk. Under the horizontal shelving method, only one of these sizes can be at any one eye level at one time and thus the consumer has to search for their preferred size if it is not at their eye level. Also, studies have shown that consumers are more likely to purchase items at eye level rather than searching or reaching for the correct size.

Stores retain the horizontal shelving method because of fears that any shelving arrangement other then the horizontal shelving of product would lead to a reduction in the amount of product that can be displayed and kept on the shelves at any one time. Another difficulty with a non-horizontal system is restocking location. When an item is stocked horizontally, it is very simple to tell when a product is no longer on the shelf, what size the product is and where it belongs. Switching to another shelving method can create increased confusion.

To maximize the consumer's choice of goods and to minimize the search time required to find the correct size item, a system of stocking items is needed that will place the entire range of product sizes at every eye level. With every size product at every level, the consumer will not have to search for the size they want and that will maximize the sale of that product allowing consumers to choose the larger size products with greater ease. This system is very efficient for the consumer and also alleviates all of the store's fears in switching to another shelving method. Trials in Australia and the United States have shown that switching to the vertical shelving method does not reduce the amount of product that can be displayed or shelved. The vertical method of shelving will cause no greater difficulty in stocking procedures. The vertical arrangement spreads the product out vertically, thus there will not be just a “hole” on the shelf but a small and easily determined ribbon of missing product. Also, confusion is easily eliminated with photos or planagrams. A digital photo or planagram can be taken or generated showing the new arrange the shelves. Employees can then just follow the picture as to where the item should be shelved and what size the product is.

### SUMMARY OF THE INVENTION

The current invention uses a ‘ribbon’ or ‘vertical’ method of stocking the shelves. Instead of designing the shelving scheme to maximize the shelf spacing, this invention maximizes the amount of product shown at every eye level. The ribbon model was specifically designed for dairy case management and its specific problems. However, any product, including bread, beer and soda, can be shelved in the ribbon fashion to maximize customer selection.

However, the ribbon model for dairy case management, in accordance with the present invention, is a completely different way to shelve and present milk. First, in the United States there are a minimum of five (5) different types of milk:

1) Whole Milk

2) 2% or Reduced Fat

3) 1% or Low Fat

4) Skim or Fat Free

5) Flavored

Next, for the presentation on the shelves, the milk is divided into two sections:

A) Meal Ingredients—This category includes of Whole Milk, 2% (Reduced Fat) and 1% (Low Fat Milk). These sizes are the one gallon, ½ gallon and one quart containers.

B) Beverages—This category includes of Whole Milk, Skim (Fat Free), and Flavored (including Soy Milk). These are the pint and ½ pint containers and some quart containers, depending on the product.

The products are not stocked by shelf size or brand name but vertically by size. Thus, from left to right on the display case there will be all of the one quart containers stocked in a column so there is a one quart container on each shelf from the lowest to the highest. Next would come the ½ gallon containers placed to the right of the quarts in the same vertical fashion. Thus, each size is a vertical ribbon of the same size product spanning from the top shelf to the bottom shelf. Then the system would repeat through the Meal Ingredients products to the Beverage products. The first size in the Beverage category would be the ½ pint containers to the left of the pint containers. Thus, this system will go from high fat to low fat milk and every size of every brand will be at every shelf level.

This system can be used to arrange any beverage or product but was developed especially for the novel problems with dairy products. Key features of the ribbon system in the United States is that nationally we sell milk in larger sizes than other countries. Using Australia as an example, they sell milk in 300 milliliter, 600 milliliter, 1 liter and 2 liter (in English measure approximations that is ½ pint, pint, quart and ½ gallon respectively). In the United States, sales of the gallon size was particularly improved by moving it off the bottom shelf, where it has traditionally resided, to be at every persons' eye level. Using this system, sales are expected to improve upwards of 10%.

Another aspect of milk that differs from most items is that it is a perishable item. Milk typically has a shelf life of approximately eleven (11) days. Since each size has its own vertical facing, it is easier to identify the product and rotate the stock, keeping the oldest product out front where the consumer will easily select them.

Even without milk's special considerations, this system can benefit any product by making every size variant available at every shelf and every persons' eye level.

### BRIEF DESCRIPTION OF THE DRAWINGS

The foregoing and other features of the invention will be more readily appreciated from the following description of an exemplary embodiment taken in conjunction with the accompanying drawings, wherein:

FIG. 1 is a schematic representation of the ribbon model for milk, where the ribbons are arranged by product alone;

FIG. 2 is a schematic representation of the ribbon model for milk, where the ribbons are arranged by product and subdivided by brand;

FIG. 3 is a schematic representation of the ribbon model for milk, where the ribbons are arranged by brand and then subdivided by product;

FIG. 4 is a reproduction of a photo of the ribbon model for milk; and

FIG. 5 are two reproductions of photos showing both a horizontal and ribbon model of shelving.

### DETAILED DESCRIPTION OF THE PRESENT INVENTION

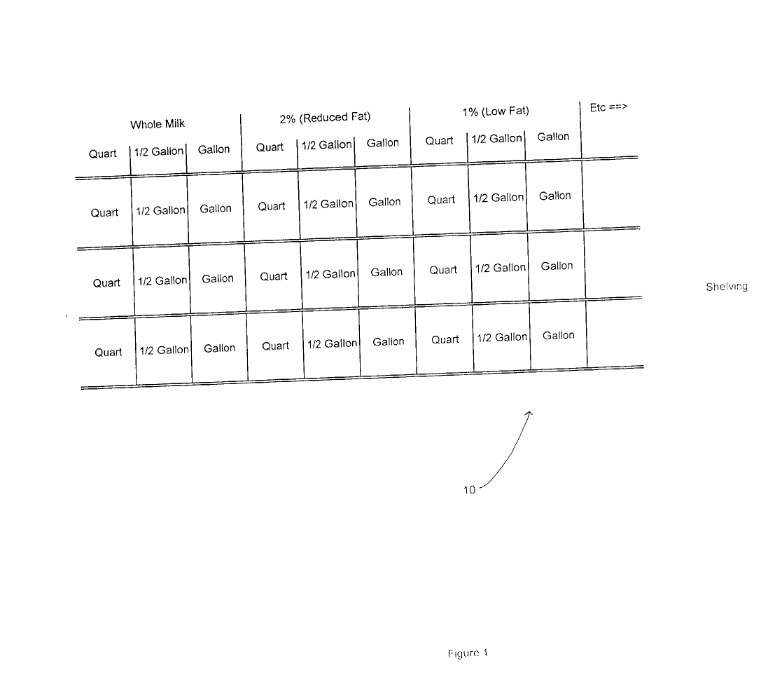

Referring now to FIGS. 1-5, a system whereby items are shelved so every size item is at every eye level in accordance with the present invention is illustrated. FIG. 1 shows a chart 10, which illustrates a ribbon model of shelving. The ribbon model places at least one of each size product on every shelf, top to bottom, in one column. Then the next size of the same product is placed in a vertical column immediately to the right of the first size. This is repeated for every size product in the same category. Then the next variant of the product is placed immediately next to it, also in corresponding columns of size order (e.g. half pint, pint, quart, half gallon, and gallon). Thus, the ribbons for each size product coalesce to form broader ribbons of each type of product (e.g., whole milk, 2% milk, 1% milk, skim milk, and flavored milk).

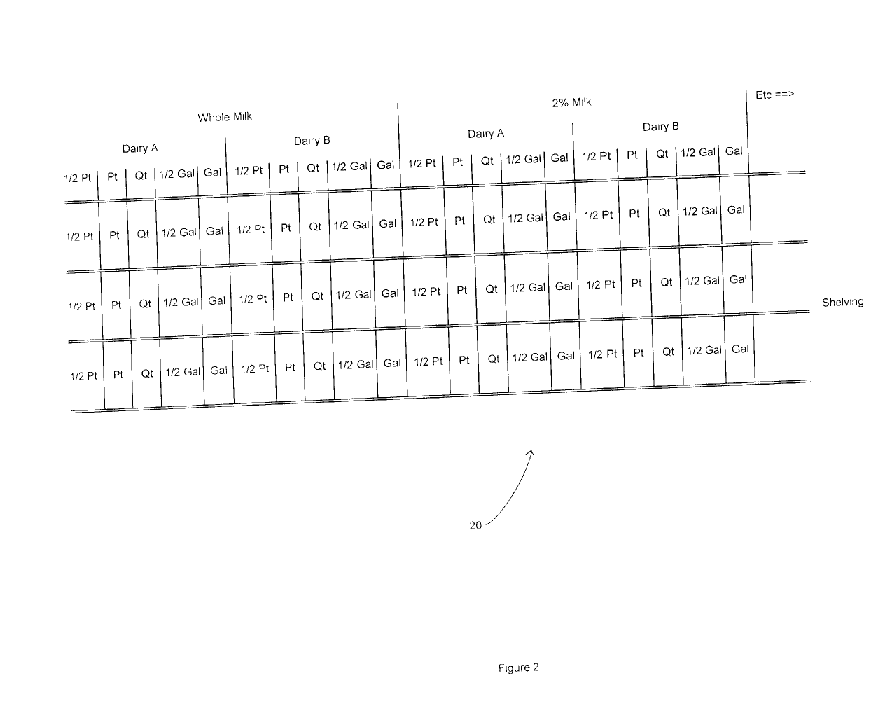

FIG. 2, shows another chart 20, which illustrates the product within a category to be divided by brand. Here, all whole milk is arranged together, however, each dairy will have their ribbons placed together. Thus, Dairy A's whole milk will have the size ribbons from smallest to largest, then Dairy B's whole milk, etc. Then it would be Dairy A's 2% milk, then Dairy B's 2% milk and this would repeat for as many dairies and milk products that each dairy sells. This arrangement works best with products that do not have very strong brand recognition. Here, consumers are not looking for a particular dairy's milk, but for milk of a specific size and fat content. Products like milk, eggs, cheese, etc. are the products best suited for this type of ribbon method.

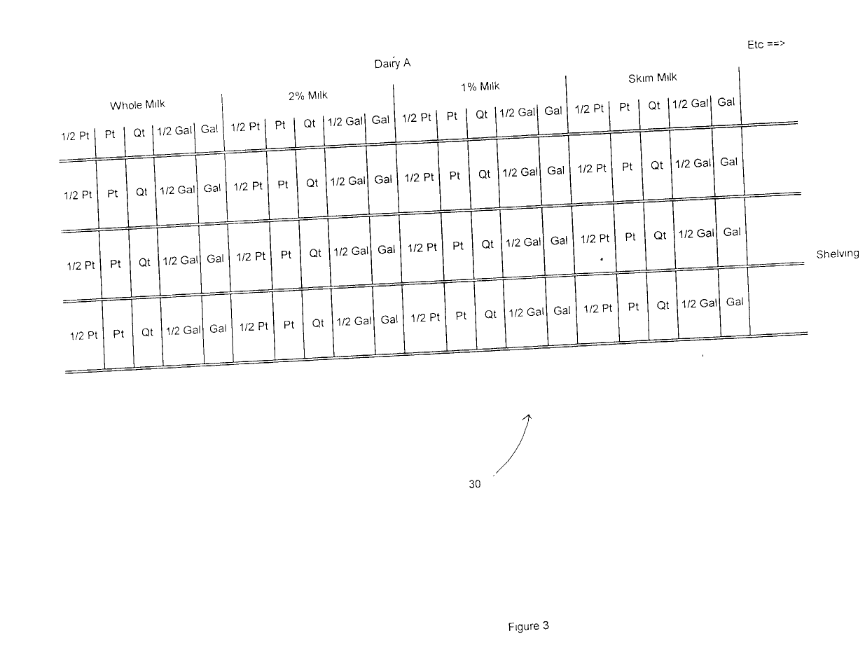

Another way of shelving products is shown in FIG. 3, which illustrates a chart 30 that divides the products by brand, then by category and then each category by size. Thus, all of Dairy A's milk, from whole to skim, will all be arranged next to each other. So, for Dairy A, all the whole milk from l pint to gallon, then the 2% milk from ½ pint to gallon, etc. Dairy B's selection is shelved in the same manner on the shelves next to Dairy A's ribbons. This method is much more effective for products with very strong brand recognition. Here, consumers want a particular brand and this method lays out every size of that brand in ribbon fashion.

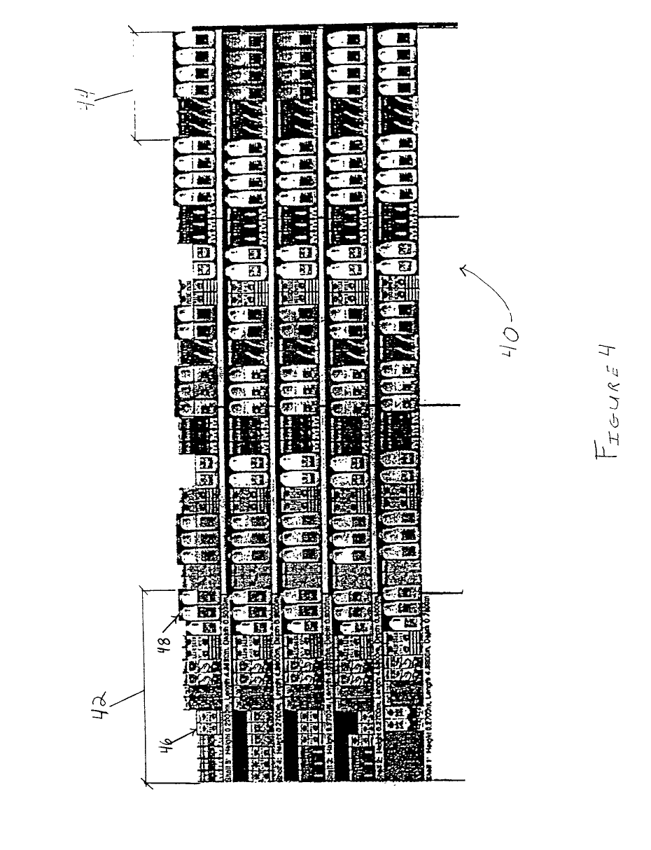

The many ribbon methods can be used for a wide variety of products. This system is extremely effective for the shelving of milk. For example, FIG. 4, shows a chart 40 where milk is shelved by category, such as from high fat content 42 to low fat content 44, and then from ½ pints 46 to gallons 48.

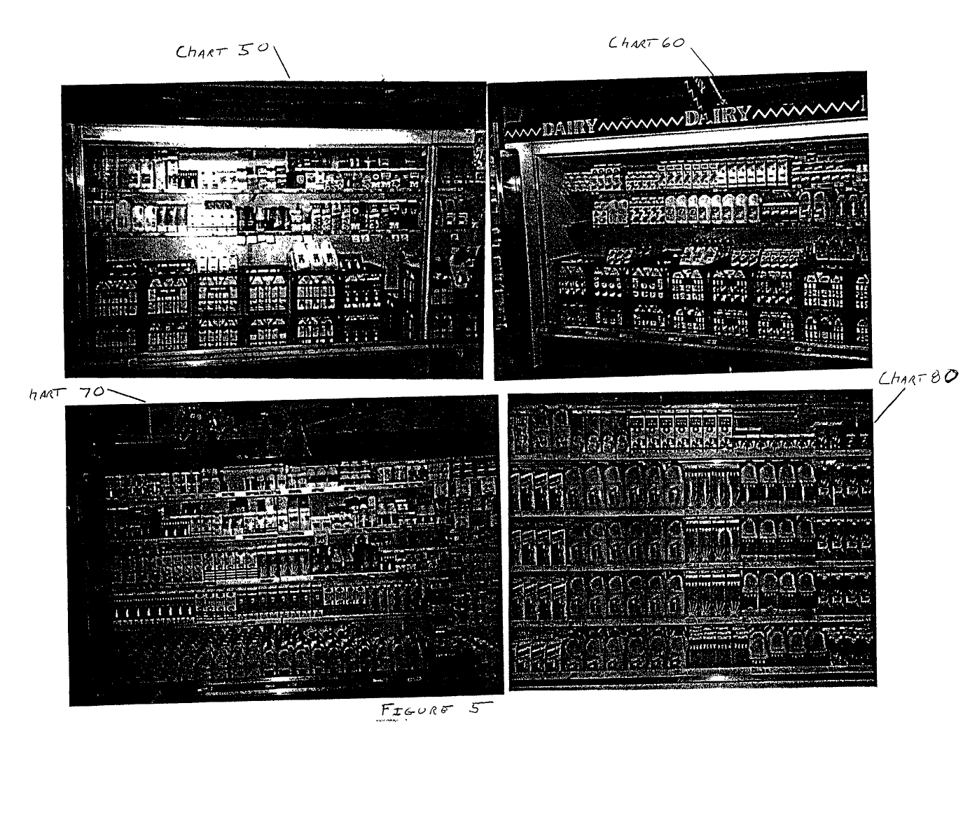

The advantages and differences can easily be seen once a horizontal and vertical shelving method shelves are directly compared. FIG. 5 shows two charts 50 and 60 that show horizontally shelved milk display cases. Charts 70 an 80 show the same respective dairy cases shelved vertically. The advantages of every size on every shelf become readily apparent.

However, while the invention has been described with particular reference to milk, the approach of the invention can be used to improve sales efficiency of any grocery item, including, but not limited to, other dairy products, bread, beer, soda, cereals, meat, cookies and canned goods.

The system for soda would preferably be the brand method because of the strong brand recognition with these products. Here, all of one brand (e.g., COKE® or PEPSI®) would be put in size ribbons by type. Thus, for the first brand, that brand's products would be arranged with regular first, then caffeine free, then sugar free and then both caffeine and sugar free would be placed in separate size ribbons. Sizes can range from individual sixteen (16) ounce (oz) bottles to full three (3) liter (1) bottles. This would then repeat for the second brand, third brand, etc.

Products other than beverages can also be shelved using this method. For example, meat can also benefit from using the present invention method of shelving by using the category ribbon method. Here all the different cuts would be shelved by weight. Thus, all the steaks in one category, stew meat in another, and chop meat, etc. in yet other categories. In each category, low poundage cuts would be arranged to the left and high poundage cuts to the right.

Less perishable items, like dry cereal, will also benefit from the ribbon method of shelving. Cereal will be most likely grouped by flavor or sugar content. Thus, all the chocolate flavored cereals, then the frosted cereals, then the non-frosted flake, etc. By using this method, especially for the children's cereals, the larger sizes will be placed closer to the eye level of the child, regardless if the child is seated in the shopping cart or is walking alongside.

The present invention is not to be limited in scope by the specific embodiments described herein. Indeed, various modifications of the invention in addition to those described herein will become apparent to those skilled in the art from the foregoing description and the accompanying figures. Such modifications are intended to fall within the scope of the appended claims.

Reference citations, patents and patent applications, and product descriptions and protocols are cited throughout this application, the disclosures of which are incorporated herein by reference in their entireties for all purposes.

What is claimed is:

1. A method of shelving products comprising the steps of:
arranging a first vertical column of a first product in a first size on a plurality of shelves;
arranging a second vertical column of the first product in a different second size on the plurality of shelves horizontally next to the first vertical column.

2. The method of claim 1, further comprising the step of arranging the first product horizontally from smallest at one end to largest at the opposite end.

3. The method of claim 1, further comprising the steps of:
arranging a second product that differs from said first product, said second product being arranged in a third vertical column of the second product in the first size on the plurality of shelves;
arranging a fourth vertical column of the second product in the second size on the plurality of shelves horizontally next to the third vertical column.

4. The method of claim 3, further comprising the steps of:
arranging the first product horizontally from smallest at one end to largest at the opposite end;
arranging the second product horizontally from smallest at one end to largest at the opposite end.

5. The method of claim 1, further comprising the steps of:
arranging a third vertical column of the first product in a different third size on the plurality of shelves horizontally next to the second column;
arranging a fourth vertical column of the first product in a different fourth size on the plurality of shelves horizontally next to the third column; and
arranging a fifth vertical column of the first product in a different fifth size on the plurality of shelves horizontally next to the fourth column.

6. The method of claim 5, wherein the first size is half pint, the second size is pint, the third size is quart, the fourth size is half gallon and the fifth size is gallon.

7. The method of claim 1, further comprising the steps of:
arranging a third product that differs from the first and second products, the third product being arranged in a third vertical column of the third product in the first size on the plurality of shelves; and
arranging a fourth product that differs from the first, second, and third products, the fourth product being arranged in a fourth vertical column of the fourth product in the first size on the plurality of shelves.

8. The method of claim 7, wherein the first product is whole milk, the second product is 2% milk, the third product is 1% milk and the fourth product is skim milk.

9. The method of claim 8, further comprising the steps of:
arranging a third vertical column of the first product in a different third size on the plurality of shelves horizontally next to the second column;
arranging a fourth vertical column of the first product in a different fourth size on the plurality of shelves horizontally next to the third column; and
arranging a fifth vertical column of the first product in a different fifth size on the plurality of shelves horizontally next to the fourth column.

10. The method of claim 9, wherein the first size is half pint, the second size is pint, the third size is quart, the fourth size is half gallon and the fifth size is gallon.

11. The method of claim 1, wherein the columns of first products are arranged immediately adjacent to each other.

12. The method of claim 3, wherein the columns of first products are arranged immediately adjacent to each other and the columns of second products are arranged immediately adjacent to each other.

13. The method of claim 1, wherein the products are selected from the group consisting of milk, bread, cereal, cookies, crackers, soda, beer, and detergent.

14. The method of claim 1, wherein the sizes of the products are selected from the group consisting of half pint, pint, quart, half gallon, and gallon.

15. The method of claim 1, wherein the sizes of the products are selected from the group consisting of 12 ounce, 16 ounce, and 20 ounce.

16. The method of claim 1, wherein the sizes of the products are selected from the group consisting of 300 milliliter, 600 milliliter, one liter, two liter and three liter.

17. The method of claim 1, wherein the products are selected from the group consisting of whole milk, 2% milk, 1% milk, and skim milk.

18. The method of claim 17, wherein the products are selected from the group consisting of flavored milk, buttermilk, cream, flavored creamers and soy milk.

19. The method of claim 18, wherein the flavored milk is selected from the group consisting of chocolate and strawberry.

20. The method of claim 17, wherein the cream is selected from the group consisting of heavy cream, half-and-half, and whipping cream.

21. The method of claim 1, wherein the first product is milk.
